(19) United States
(12) Patent Application Publication
(10) Pub. No.: US 2007/0178953 A1
(43) Pub. Date: Aug. 2, 2007

(54) Method of generating a result of a racing game

(75) Inventors: Clyde Wilson Torkington, Victoria (AU); Howard Silver, Victoria (AU)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: TABCORP INTERNATIONAL PTY LTD, VICTORIA (AU)

(21) Appl. No.: 11/587,424

(22) PCT Filed: Apr. 25, 2005
(86) PCT No.: PCT/AU05/00595

§ 371 Date: Dec. 19, 2006

(30) Foreign Application Priority Data
Apr. 27, 2004 (AU) 2004902219

(51) Int. Cl. A63F 13/00

(52) U.S. Cl. 463/6

(57) ABSTRACT

A method of generating a result of a racing game having a plurality of participants to enable fixed odds betting on the racing game. The result of the racing game is generated from the result of an identifier selection game. The method comprises allocating unique subsets of a set of identifiers used in the identifier selection game to each of the plurality of participants, defining a ranking of said participants from highest to lowest, running said identifier selection game by randomly selecting a result subset of identifiers from the set of identifiers, and determining first place in said race by determining which of said plurality of participants has the most identifiers of said result subset in the participant's allocated subset, and if two or more participants have the same number of identifiers in their respective allocated subsets, determining first place by determining which of the two or more participants is ranked highest.

### FIELD OF THE PRESENT INVENTION

The present invention relates to a method and apparatus for generating a result of a racing game which enables fixed odds betting on the game, the result of the racing game being generated from identifiers drawn in an identifier selection game.

### BACKGROUND TO THE INVENTION

Keno is an ancient Chinese numbers game based on the drawing of 20 balls from a cage containing 80 balls numbered 1,2, . . . , 80. In the last twenty or so years the game has become fully computerised and this has lead to a very fast game with a draw every 3-5 minutes. Many jurisdictions allow the use of an internal software based result generation technique using an approved pseudo Random Number Generator or an external “Black Box” result generator based on a software pseudo-Random Number Generator or a hardware white noise sampler.

Keno results are typically graphically presented as an 8×10 grid (matrix) as shown in FIG. 1.

Examples of common and exotic Keno bet types are as follows:
In the bet type “Spots & Ways”, players bet on N numbers (1<=N<=15). The result is determined by finding out how many, say C, of the N numbers were drawn (“caught”) and consulting a Prize Table that specifies the prize for catching C from N;
In the bet type “Heads or Tails”, players bet on more numbers being drawn from the lower 40 numbers—“Heads” OR vice versa—“Tails” OR on an exact split (10:10) between the top & bottom half—“Evens”. The result is determined by counting how many of the drawn numbers are less than 41. If this exceeds 10 all “Heads” bettors win a published prize and all “Tails” & “Evens” bettors lose. If this equals 10 all “Evens” bettors win a different prize whilst all “Heads” & “Tails” bettors lose. If it is less than 10 all “Tails” bettors win the same prize as the “Head” prize whilst all “Evens” & “Tails” bettors lose.
In the bet type “Lucky Last”, players bet on the last number drawn. A fixed prize is won if the selected number is the last one drawn.
In the game “Keno Racing”, players bet on eight groups of ten numbers (1 . . . 10), (11 . . . 20), . . . ,(71 . . . 80) The groups are represented as a race between animated horses. As each number is drawn, the horse whose group the number falls within is moved forward a fixed amount. After the last number is drawn and applied to “horse” movement, the most advanced “horse” wins followed by next most advanced second & so on. Dead heats are decided in favour of the first horse to arrive at the final position—i.e. the first horse whose last number was drawn first. A fixed prize, independent of the group number or “horse” is offered for bets on the winner
In the game “Keno Roulette”, players bet on what part of the matrix of FIG. 1 the first drawn number lies in. A variety of pattern propositions are available to bet upon including:
   “Straight Up”=nominate the exact first number;
   “Quarters”=given the results matrix is divided into four quarters, nominate which of the quarters the first number resides within; and
   “Rows”, “Corners”, etc.

Trackside is a game developed by the present applicant that provides an animated race between a number of “participants”. Players are offered fixed odds on a sub-set of standard horse racing bet types. The win odds are nominated by the game operator and the system derives the place, quinella and trifecta odds from these using published algorithms. Each game result is generated by either an approved internal software algorithm or an external mechanical ball draw taking into account the unequal chance of winning of each “participants”. For betting purposes, a Trackside result comprises the first three “participants”. These are called the race “placings”. After the winner has been determined from a set of 12 participants, second is determined by the same algorithm as used to determine the winner excepting the trial (“race”) is between 11 participants and their respective chance of winning the trial for second has been adjusted to take account of removal of the winner of the trial for first. Third placing is similarly determined by a further trial between the remaining 10 participants.

In a Win bet, players bet on which participant wins the race. Odds are offered dependent on the participant number, for coming first past the post (winning).

In a Place bet, players bet on a participant being placed. Odds are offered dependent on the participant number, for being placed.

In an Each Way bet, players bet on a participant winning and/or being placed. Odds are offered dependent on the participant number, for winning and/or being placed.

In a Quinella bet, players bet on two participants coming first and second in either order. Odds are offered based on each permutation of the quinella.

In a Trifecta bet, players bet on three contestants coming first, second and third in exact nominated order. Odds are offered based on each permutation of the trifecta. Accordingly, it would be desirable to generate a result for a Trackside type race game from a Keno type identifier draw game as this will allow Trackside type games to be run concurrently with a Keno type game without the need to run a separate random number generator. Providing such a game may also provide an additional enjoyable game to improve player enjoyment in conjunction with a Keno type game.

### SUMMARY OF THE INVENTION

The invention provides a method of generating a result of a racing game having a plurality of participants to enable fixed odds betting on the racing game, the result of the racing game being generated from the result of an identifier selection game, the method comprising:
allocating unique subsets of a set of identifiers used in the identifier selection game to each of the plurality of participants;
defining a ranking of said participants from highest to lowest;
running said identifier selection game by randomly selecting a result subset of identifiers from the set of identifiers; and
determining first place in said race by determining which of said plurality of participants has the most identifiers of said result subset in the participant's allocated subset, and if two or more participants have the same number of identifiers in their respective allocated subsets, determining first place by determining which of the two or more participants is ranked highest.

In embodiments where generating the result involves generating second place, and wherein if first place was determined by rank, second place is determined by the next highest rank, and if first place is determined by the number of identifiers in the allocated subset of the first placed participant, second place is determined as being the highest ranked participant which has the next greatest number of identifiers in their allocated subset.

Further places can be allocated as necessary in an order defined firstly by the number of identifiers in respective participant's allocated subsets and secondly by the relative rankings of the participants.

Thus, the results of the race are random but biased in accordance with the ranking of participants thereby modifying the odds of participants winning and allowing different odds to be offered on that basis.

Thus, if, as in one embodiment, the subsets are of equal size, the highest ranked participant will have the lowest return on outlay, the second ranked participant will have the second lowest return on outlay with the return on outlay increasing to a greatest return on the lowest ranked participant.

In some embodiments of the invention, the spread of the odds can be varied by allocating subsets of different numbers of identifiers to at least some of the participants. Typically, this will involve allocating larger subsets to higher ranked participants than to lower ranked participants so that the relative odds of each participant winning are consistent with the participant's ranking. However, this need not necessarily be the case and larger subsets could be allocated in another way—for example, randomly—to obtain other interesting spreads of odds.

In one embodiment, the participants are horses in an animated horse race.

Typically, the identifiers will be numbers.

In one embodiment, the set of numbers is eighty numbers and the result subset consists of twenty numbers randomly selected from the set of eighty.

The number of participants and the sizes of the subsets can be varied in a number of ways. For example: eight participants with subsets of ten; ten participants with subsets of eight; twelve participants with the eight highest ranked participants having subsets of seven and the four lowest ranked participants having subsets of six; or twelve participants with two participants having subsets of eight, six participants having subsets of seven, two participants having subsets of six and two participants having subsets of five.

In one embodiment, the set of identifiers are displayed as a matrix and contiguous portions of the matrix are allocated to each participant when allocating the subsets, whereby it can readily be determined by inspecting the matrix to which participants identifiers in said result set belong.

Apparatus for generating a result of a racing game having a plurality of participants to enable fixed odds betting on the racing game the result of the racing game being generated from the result of an identifier selection game, the apparatus comprising:
an identifier selector for randomly selecting a result subset of identifiers from a set of identifiers to thereby generate a result of the identifier selection game; and
a result generator for determining first place in said race by determining which of said plurality of participants has the most identifiers of said result subset in a participant allocated unique subset of identifiers, and if two or more participants have the same number of identifiers in their respective allocated subsets, determining first place by determining which of the two or more participants is ranked highest from pre-allocated rankings of said participants from highest to lowest.

In embodiments where generating the result involves generating a second place, if first place was determined by rank, the result generator determines second place by the next highest rank, where first place is determined by the number of identifiers in the allocated subset of the first placed participant, the result generator determines second place as being the highest ranked participant which has the next greatest number of identifiers in their allocated subset.

The result generator can determine further places as necessary in an order defined firstly by the number of identifiers and secondly by the relative rankings of the participants.

As in the method of the embodiments, the spread of the odds of participants can be varied by pre-allocating subsets of different numbers of identifiers to respective participants.

### BRIEF DESCRIPTION OF THE DRAWINGS

FIG. 1 is a matrix of Keno results; and

FIG. 2 is a schematic diagram of an apparatus for determining the result of a game.

### DESCRIPTION OF THE PREFERRED EMBODIMENT

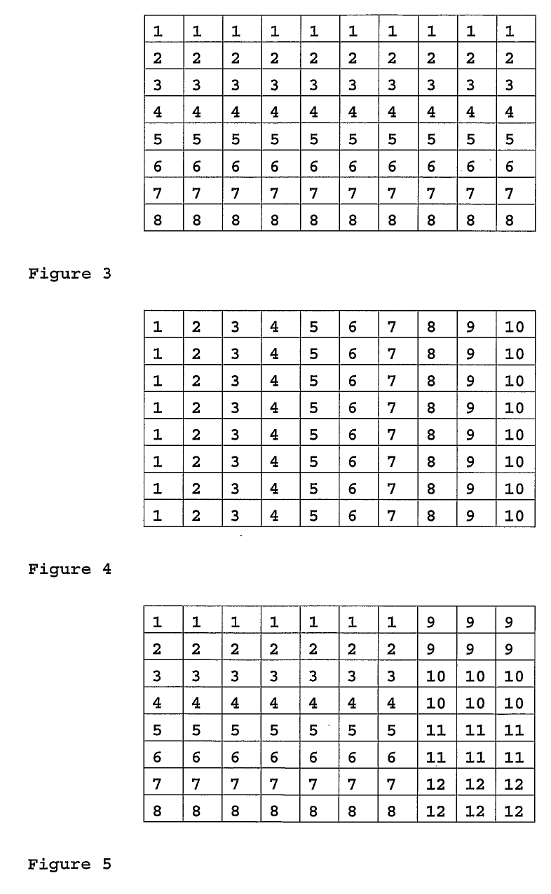

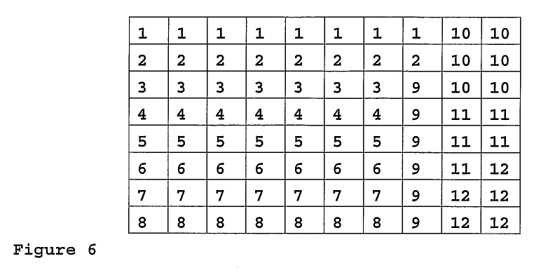

FIG. 2 is a schematic diagram of an apparatus for determining the result of an electronic game of the preferred embodiment. In the preferred embodiment, the electronic game is a horse racing game called Trackside™ where players bet or wager on the result of the electronic game. The individual horses in the electronic game provide a plurality of participants which can be bet upon. Players of the game can place fixed odds bets on the horses in the same manner as fixed odds bets can be placed on conventional horse races. To stimulate customer interest in such a game, it is necessary to allow players to bet at a variety of horses at different odds.

In the preferred embodiment, the electronic game is controlled by software run by a computing device in the form of a processor of a host computer 101. Once the result of the game has been determined, the host computer 101 instructs the graphics engine 102 to create the horse race simulation. The graphics engine 102 then causes the simulated horse race to be displayed on displays 105.

To generate player interest in the game it is necessary to offer a variety of fixed odds bets with varying returns for player outlay so that players can either seek to obtain a small return by betting on a favourite with a higher chance of winning or seek to obtain a larger return by betting on an outsider. The preferred embodiment provides a technique for manipulating the results of identifier selection game such as Keno where there are set of eighty numbers from which a subset of twenty numbers are selected to generate the result of the racing game. It is preferred that the racing game is run in conjunction with the Keno game so that when the result of the Keno game has been determined, simulation of the Trackside game occur in conjunction with display of the Keno result.

In the preferred embodiment, the method involves allocating unique subsets of a set of eighty numbers (identifiers) to each of the plurality of participants. A ranking is also allocated to the participants form highest to lowest. In the preferred embodiment, horse one has the highest ranking, horse two the second highest ranking etc. In a Keno draw, a set of twenty numbers referred to herein as the results subset is drawn from the set of numbers. First place in the race is determined by determining which of the horses has the most numbers of the result subset in their allocated subsets. If two or more horses have the same number of identifiers in their respective allocated subsets, first place is determined by determining which of the two or more horses is ranked higher.

The use of an arbitrary ranking in determination of the results biases the results so that the highest ranked horse will have a higher chance of winning than the next highest ranked horse with the lowest ranked horse having the lowest chance of winning. Accordingly, as the chances of individual horses vary unlike in conventional Keno Racing, different odds can be offered on different horses.

Subsequent places are also allocated in an order defined firstly by the number of identifiers of a horse's subset which are in the result subset and secondly by the relative rankings of the participants. Thus, the bias towards higher ranked horses will be continued in the allocation of further places.

In a typical Trackside game, the result is determined by determining the identity of the first three place getters. This result is then animated and displayed as described above. Players can bet on the chance of an individual horse winning or the chance of a horse obtaining a place. Players can also bet using other conventional horse racing bet types such as:
quinellas where the player bets on the first and second place getters in a race;
an exacta where the bet is placed on the first and second places but where order is important; and
on a trifecta where bets are placed on the first three place getters.

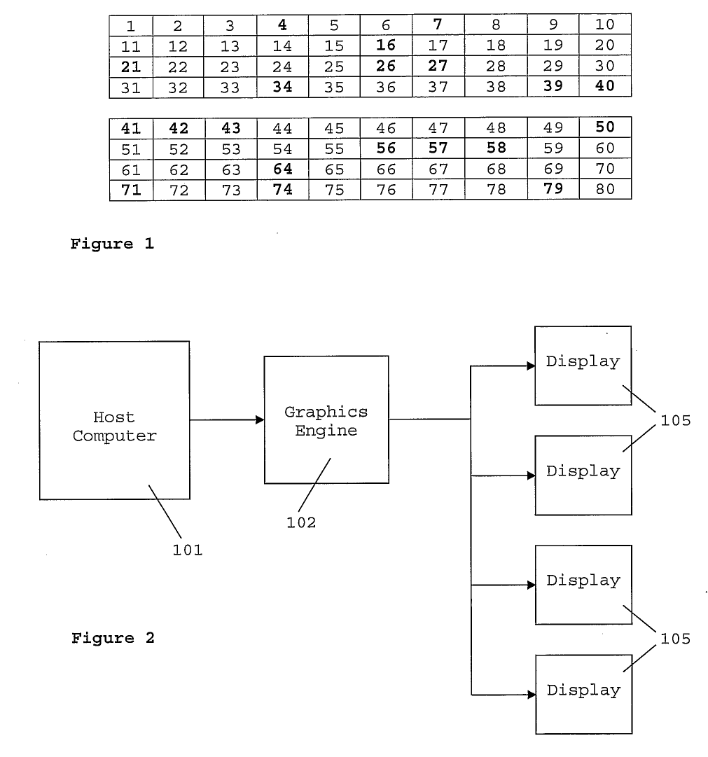

When the preferred embodiment is run in conjunction with a Keno draw, the subsets of numbers which are allocated to individual horses are preferably chosen so that they are next to one another (i.e. contiguous) in the matrix of Keno results which is normally displayed as an eight by ten grid or two four by ten grids as shown in FIG. 1. In a typical Keno game, the results are displayed by highlighting individual numbers on the grid of eighty numbers to show that they belong to the result subset as shown in FIG. 1 by the bold numbers. By choosing subsets of numbers for each horse which are next to one another, a person watching the Keno result can readily see in which part of the matrix the result identifiers are falling and thereby monitor the chances of a horse they have bet on winning. Typically, a Keno draw involves an animation of the results which have previously been chosen using a standard technique such as random number generation. If, as in one embodiment, this is displayed alongside an animated horse race the player can see for example on one display screen the Keno results as they are drawn and on the other display screen the animated horse race and so will be encouraged if they see that two or three numbers have been drawn early in the Keno draw in the subset which belongs to the horse they have selected, thus building excitement in the game.

Several examples of possible numbers of horses and subset sizes will now be described to further illustrate the preferred embodiment.

### EXAMPLE 1

In the first example there are a field of eight runners in the game ranked from highest (horse 1) to lowest (horse 8). Each participant (runner) is represented by ten Keno balls in the matrix as shown in FIG. 3 where each horse has a row of Keno numbers. With eighty Keno balls in the Keno matrix and twenty drawn Keno balls relevant to determine race result there are 796,510 different outcomes of ball quantities drawn against each runner.

In this example, each runner has the same quantity of Keno balls but when two runners have the same quantity of balls drawn, the lower numbered runner (i.e. higher ranked) ranks above a higher numbered runner. The order of the balls drawn from Keno is not relevant to derive the result.

The win, place, and quinella dividends are shown in Tables 1, 2 and 3 respectively including the return to player (RTP).

TABLE 1
WIN DIVIDENDS CALCULATOR

| | | Target | | Desired RTP 80% |
|---|---|---|---|---|
| | Actual | Dividend | Rounded $1 | Rounded Player |
| Result | Probability | for $1 | Dividend | Return |
| 1 | 19.5292% | $4.10 | $4.10 | 80.0697% |
| 2 | 16.4032% | $4.88 | $4.90 | 80.3756% |
| 3 | 14.1236% | $5.66 | $5.70 | 80.5047% |
| 4 | 12.3941% | $6.45 | $6.50 | 80.5618% |
| 5 | 11.0092% | $7.27 | $7.30 | 80.3668% |
| 6 | 9.8381% | $8.13 | $8.10 | 79.6887% |
| 7 | 8.8092% | $9.08 | $9.10 | 80.1638% |
| 8 | 7.8934% | $10.14 | $10.10 | 79.7233% |
| TOTAL | 100.0000% | | AVERAGE: | 80.1818% |

TABLE 2
PLACE DIVIDENDS CALCULATOR

| | | Target | | Desired RTP 80% |
|---|---|---|---|---|
| | Actual | Dividend | Rounded $1 | Rounded Player |
| Result | Probability | for $1 | Dividend | Return |
| 1 | 48.9347% | $1.63 | $1.60 | 78.2954% |
| 2 | 46.3314% | $1.73 | $1.70 | 78.7634% |
| 3 | 43.4129% | $1.84 | $1.80 | 78.1432% |
| 4 | 39.9514% | $2.00 | $2.00 | 79.9027% |
| 5 | 36.0390% | $2.22 | $2.20 | 79.2859% |
| 6 | 31.9875% | $2.50 | $2.50 | 79.9688% |
| 7 | 28.2158% | $2.84 | $2.80 | 79.0042% |
| 8 | 25.1274% | $3.18 | $3.20 | 80.4076% |
| TOTAL | 300.0000% | | AVERAGE: | 79.2214% |

TABLE 3
QUINELLA DIVIDENDS CALCULATOR

| | | Target | | Desired RTP 80% |
|---|---|---|---|---|
| | Actual | Dividend | Rounded $1 | Rounded Player |
| Result | Probability | for $1 | Dividend | Return |
| 1 & 2 | 8.0990% | $9.88 | $9.90 | 80.1803% |
| 1 & 3 | 6.5235% | $12.26 | $12.30 | 80.2386% |
| 1 & 4 | 5.4496% | $14.68 | $14.70 | 80.1086% |
| 1 & 5 | 4.7437% | $16.86 | $16.90 | 80.1688% |
| 1 & 6 | 4.2943% | $18.63 | $18.60 | 79.8740% |
| 1 & 7 | 4.0092% | $19.95 | $20.00 | 80.1840% |
| 1 & 8 | 3.8155% | $20.97 | $21.00 | 80.1256% |
| 2 & 3 | 5.7943% | $13.81 | $13.80 | 79.9619% |
| 2 & 4 | 4.7204% | $16.95 | $16.90 | 79.7756% |
| 2 & 5 | 4.0146% | $19.93 | $19.90 | 79.8905% |
| 2 & 6 | 3.5652% | $22.44 | $22.40 | 79.8600% |
| 2 & 7 | 3.2801% | $24.39 | $24.40 | 80.0339% |
| 2 & 8 | 3.0864% | $25.92 | $25.90 | 79.9374% |
| 3 & 4 | 4.1966% | $19.06 | $19.10 | 80.1549% |
| 3 & 5 | 3.4907% | $22.92 | $22.90 | 79.9380% |
| 3 & 6 | 3.0413% | $26.30 | $26.30 | 79.9869% |
| 3 & 7 | 2.7562% | $29.03 | $29.00 | 79.9305% |
| 3 & 8 | 2.5625% | $31.22 | $31.20 | 79.9510% |
| 4 & 5 | 3.1294% | $25.56 | $25.60 | 80.1138% |
| 4 & 6 | 2.6800% | $29.85 | $29.90 | 80.1329% |
| 4 & 7 | 2.3949% | $33.40 | $33.40 | 79.9906% |
| 4 & 8 | 2.2012% | $36.34 | $36.30 | 79.9048% |
| 5 & 6 | 2.4445% | $32.73 | $32.70 | 79.9365% |
| 5 & 7 | 2.1594% | $37.05 | $37.00 | 79.8993% |
| 5 & 8 | 1.9657% | $40.70 | $40.70 | 80.0059% |
| 6 & 7 | 2.0165% | $39.67 | $39.70 | 80.0537% |
| 6 & 8 | 1.8228% | $43.89 | $43.90 | 80.0198% |
| 7 & 8 | 1.7422% | $45.92 | $45.90 | 79.9658% |
| TOTAL | 100.0000% | | AVERAGE: | 80.0116% |

### EXAMPLE 2

In the second example, there is a field of ten runners in the game with horse 1 being the highest ranked and horse 10 being the lowest ranked. Each runner is represented by eight Keno balls in the matrix as shown in FIG. 4 where each horse has a column. With eighty Keno balls in the Keno matrix and twenty drawn Keno results relevant to determine race result there are 8,337,880 different outcomes of ball quantities drawn against each runner.

The win, place and quinella dividends are shown in Tables 4, 5 and 6 respectively. It will be apparent that the use of ten runners gives a broader spread of odds than the field of eight runners of Example 1.

TABLE 4
WIN DIVIDENDS CALCULATOR

| | | Target | | Desired RTP 80% |
|---|---|---|---|---|
| | Actual | Dividend | Rounded $1 | Rounded Player |
| Result | Probability | for $1 | Dividend | Return |
| 1 | 17.6013% | $4.55 | $4.50 | 79.2060% |
| 2 | 14.8092% | $5.40 | $5.40 | 79.9699% |
| 3 | 12.5798% | $6.36 | $6.40 | 80.5108% |
| 4 | 10.8112% | $7.40 | $7.40 | 80.0027% |
| 5 | 9.4199% | $8.49 | $8.50 | 80.0693% |
| 6 | 8.3323% | $9.60 | $9.60 | 79.9899% |
| 7 | 7.4837% | $10.69 | $10.70 | 80.0754% |
| 8 | 6.8183% | $11.73 | $11.70 | 79.7744% |
| 9 | 6.2888% | $12.72 | $12.70 | 79.8674% |
| 10 | 5.8555% | $13.66 | $13.70 | 80.2199% |
| TOTAL | 100.0000% | 1 | AVERAGE: | 79.9686% |

TABLE 5
PLACE DIVIDENDS CALCULATOR

| | | Target | | Desired RTP 80% |
|---|---|---|---|---|
| | Actual | Dividend | Rounded $1 | Rounded Player |
| Result | Probability | for $1 | Dividend | Return |
| 1 | 42.3764% | $1.89 | $1.90 | 80.5152% |
| 2 | 37.7288% | $2.12 | $2.10 | 79.2306% |
| 3 | 34.2584% | $2.34 | $2.30 | 78.7943% |
| 4 | 31.8338% | $2.51 | $2.50 | 79.5844% |
| 5 | 30.0370% | $2.66 | $2.70 | 81.0999% |
| 6 | 28.4407% | $2.81 | $2.80 | 79.6339% |
| 7 | 26.7758% | $2.99 | $3.00 | 80.3274% |
| 8 | 24.9304% | $3.21 | $3.20 | 79.7773% |
| 9 | 22.8964% | $3.49 | $3.50 | 80.1376% |
| 10 | 20.7223% | $3.86 | $3.90 | 80.8169% |
| TOTAL | 300.0000% | 1 | AVERAGE: | 79.9917% |

TABLE 6
QUINELLA DIVIDENDS CALCULATOR

| | | Target | | Desired RTP 80% |
|---|---|---|---|---|
| | Actual | Dividend | Rounded $1 | Rounded Player |
| Result | Probability | for $1 | Dividend | Return |
| 1 & 2 | 5.6049% | $14.27 | $14.30 | 80.1501% |
| 1 & 3 | 4.7232% | $16.94 | $16.90 | 79.8214% |
| 1 & 4 | 4.0454% | $19.78 | $19.80 | 80.0987% |
| 1 & 5 | 3.4979% | $22.87 | $22.90 | 80.1024% |
| 1 & 6 | 3.0524% | $26.21 | $26.20 | 79.9720% |
| 1 & 7 | 2.6940% | $29.70 | $29.70 | 80.0118% |
| 1 & 8 | 2.4116% | $33.17 | $33.20 | 80.0659% |
| 1 & 9 | 2.1950% | $36.45 | $36.40 | 79.8994% |
| 1 & 10 | 2.0346% | $39.32 | $39.30 | 79.9588% |
| 2 & 3 | 4.4041% | $18.16 | $18.20 | 80.1542% |
| 2 & 4 | 3.7263% | $21.47 | $21.50 | 80.1156% |
| 2 & 5 | 3.1788% | $25.17 | $25.20 | 80.1067% |
| 2 & 6 | 2.7333% | $29.27 | $29.30 | 80.0851% |
| 2 & 7 | 2.3749% | $33.69 | $33.70 | 80.0346% |
| 2 & 8 | 2.0925% | $38.23 | $38.20 | 79.9350% |
| 2 & 9 | 1.8760% | $42.64 | $42.60 | 79.9156% |
| 2 & 10 | 1.7155% | $46.63 | $46.60 | 79.9419% |
| 3 & 4 | 3.5093% | $22.80 | $22.80 | 80.0128% |
| 3 & 5 | 2.9619% | $27.01 | $27.00 | 79.9704% |
| 3 & 6 | 2.5163% | $31.79 | $31.80 | 80.0187% |
| 3 & 7 | 2.1579% | $37.07 | $37.10 | 80.0597% |
| 3 & 8 | 1.8756% | $42.65 | $42.70 | 80.0868% |
| 3 & 9 | 1.6590% | $48.22 | $48.20 | 79.9630% |
| 3 & 10 | 1.4985% | $53.39 | $53.40 | 80.0210% |
| 4 & 5 | 2.7918% | $28.66 | $28.70 | 80.1241% |
| 4 & 6 | 2.3462% | $34.10 | $34.10 | 80.0063% |
| 4 & 7 | 1.9879% | $40.24 | $40.20 | 79.9119% |
| 4 & 8 | 1.7055% | $46.91 | $46.90 | 79.9872% |
| 4 & 9 | 1.4889% | $53.73 | $53.70 | 79.9538% |
| 4 & 10 | 1.3284% | $60.22 | $60.20 | 79.9718% |
| 5 & 6 | 2.2043% | $36.29 | $36.30 | 80.0154% |
| 5 & 7 | 1.8459% | $43.34 | $43.30 | 79.9281% |
| 5 & 8 | 1.5635% | $51.17 | $51.20 | 80.0532% |
| 5 & 9 | 1.3470% | $59.39 | $59.40 | 80.0091% |
| 5 & 10 | 1.1865% | $67.43 | $67.40 | 79.9695% |
| 6 & 7 | 1.7266% | $46.33 | $46.30 | 79.9412% |
| 6 & 8 | 1.4442% | $55.39 | $55.40 | 80.0096% |
| 6 & 9 | 1.2276% | $65.17 | $65.20 | 80.0415% |
| 6 & 10 | 1.0672% | $74.96 | $75.00 | 80.0376% |
| 7 & 8 | 1.3451% | $59.48 | $59.50 | 80.0328% |
| 7 & 9 | 1.1285% | $70.89 | $70.90 | 80.0109% |
| 7 & 10 | 0.9680% | $82.64 | $82.60 | 79.9602% |
| 8 & 9 | 1.0477% | $76.36 | $76.40 | 80.0452% |
| 8 & 10 | 0.8872% | $90.17 | $90.20 | 80.0299% |
| 9 & 10 | 0.8230% | $97.20 | $97.20 | 79.9991% |
| TOTAL | 100.0000% | 1 | AVERAGE: | 80.0120% |

### EXAMPLE 3

In the third example there is a field of twelve runners in the game. Each runner is represented by 6 or 7 Keno balls in the matrix as shown in FIG. 5. The top eight ranked horses (numbers 1-8) are allocated subsets of seven numbers and the other horses (9-12) are allocated six numbers. For eighty Keno balls in the Keno matrix and twenty drawn Keno results relevant to determine race result, there are 64,123,367 different outcomes of ball quantities drawn against each runner. Again, when two runners have the same quantity of balls drawn, the lower numbered runner ranks above a higher numbered runner.

As shown in Tables 7, 8 and 9, this provides a still greater spread of odds for wins, places, quinellas and trifectas than in the previous examples. Indeed, the least likely trifecta in this Example will produce a payout of about $600,000 unless a cap (e.g. $100,000) is applied to the trifecta as may be appropriated. This is significantly larger than the largest trifecta for example 2 which is in the order of $16,000 for an 80% return to player.

TABLE 7
WIN DIVIDENDS CALCULATOR

| | | Target | | Desired RTP 80% |
|---|---|---|---|---|
| | Actual | Dividend | Rounded $1 | Rounded Player |
| Result | Probability | for $1 | Dividend | Return |
| 1 | 17.2259% | $4.64 | $4.60 | 79.2391% |
| 2 | 14.6928% | $5.44 | $5.40 | 79.3412% |
| 3 | 12.6835% | $6.31 | $6.30 | 79.9059% |
| 4 | 11.0248% | $7.26 | $7.30 | 80.4810% |
| 5 | 9.6308% | $8.31 | $8.30 | 79.9356% |
| 6 | 8.4554% | $9.46 | $9.50 | 80.3263% |
| 7 | 7.4686% | $10.71 | $10.70 | 79.9138% |
| 8 | 6.6461% | $12.04 | $12.00 | 79.7531% |
| 9 | 3.4239% | $23.37 | $23.40 | 80.1188% |
| 10 | 3.1442% | $25.44 | $25.40 | 79.8622% |
| 11 | 2.9042% | $27.55 | $27.50 | 79.8643% |
| 12 | 2.6999% | $29.63 | $29.60 | 79.9178% |
| TOTAL | 100.0000% | 1 | AVERAGE: | 79.8883% |

TABLE 8
PLACE DIVIDENDS CALCULATOR

| | | Target | | Desired RTP 80% |
|---|---|---|---|---|
| | Actual | Dividend | Rounded $1 | Rounded Player |
| Result | Probability | for $1 | Dividend | Return |
| 1 | 44.3587% | $1.80 | $1.80 | 79.8456% |
| 2 | 39.3150% | $2.03 | $2.00 | 78.6299% |
| 3 | 34.3753% | $2.33 | $2.30 | 79.0633% |
| 4 | 30.1470% | $2.65 | $2.70 | 81.3970% |
| 5 | 26.9330% | $2.97 | $3.00 | 80.7990% |
| 6 | 24.6958% | $3.24 | $3.20 | 79.0264% |
| 7 | 23.1853% | $3.45 | $3.50 | 81.1486% |
| 8 | 22.0941% | $3.62 | $3.60 | 79.5387% |
| 9 | 14.4502% | $5.54 | $5.50 | 79.4759% |
| 10 | 13.9697% | $5.73 | $5.70 | 79.6271% |
| 11 | 13.4912% | $5.93 | $5.90 | 79.5978% |
| 12 | 12.9849% | $6.16 | $6.20 | 80.5062% |
| TOTAL | 300.0000% | 1 | AVERAGE: | 79.8880% |

TABLE 9
QUINELLA DIVIDENDS CALCULATOR

| | | Target | | Desired RTP 80% |
|---|---|---|---|---|
| | Actual | Dividend | Rounded $1 | Rounded Player |
| Result | Probability | for $1 | Dividend | Return |
| 1 & 2 | 5.1511% | $15.53 | $15.50 | 79.8426% |
| 1 & 3 | 4.2043% | $19.03 | $19.00 | 79.8817% |
| 1 & 4 | 3.6177% | $22.11 | $22.10 | 79.9516% |
| 1 & 5 | 3.2163% | $24.87 | $24.90 | 80.0854% |
| 1 & 6 | 2.9101% | $27.49 | $27.50 | 80.0279% |
| 1 & 7 | 2.6572% | $30.11 | $30.10 | 79.9809% |
| 1 & 8 | 2.4397% | $32.79 | $32.80 | 80.0237% |
| 1 & 9 | 1.4018% | $57.07 | $57.10 | 80.0406% |
| 1 & 10 | 1.3176% | $60.72 | $60.70 | 79.9793% |
| 1 & 11 | 1.2409% | $64.47 | $64.50 | 80.0388% |
| 1 & 12 | 1.1713% | $68.30 | $68.30 | 80.0009% |
| 2 & 3 | 3.7812% | $21.16 | $21.20 | 80.1616% |
| 2 & 4 | 3.1946% | $25.04 | $25.00 | 79.8657% |
| 2 & 5 | 2.7932% | $28.64 | $28.60 | 79.8853% |
| 2 & 6 | 2.4870% | $32.17 | $32.20 | 80.0818% |
| 2 & 7 | 2.2341% | $35.81 | $35.80 | 79.9801% |
| 2 & 8 | 2.0167% | $39.67 | $39.70 | 80.0612% |
| 2 & 9 | 1.1433% | $69.98 | $70.00 | 80.0283% |
| 2 & 10 | 1.0591% | $75.53 | $75.50 | 79.9631% |
| 2 & 11 | 0.9824% | $81.43 | $81.40 | 79.9682% |
| 2 & 12 | 0.9128% | $87.64 | $87.60 | 79.9626% |
| 3 & 4 | 2.9587% | $27.04 | $27.00 | 79.8851% |
| 3 & 5 | 2.5573% | $31.28 | $31.30 | 80.0426% |
| 3 & 6 | 2.2511% | $35.54 | $35.50 | 79.9139% |
| 3 & 7 | 1.9982% | $40.04 | $40.00 | 79.9265% |
| 3 & 8 | 1.7807% | $44.93 | $44.90 | 79.9551% |
| 3 & 9 | 1.0038% | $79.69 | $79.70 | 80.0065% |
| 3 & 10 | 0.9197% | $86.99 | $87.00 | 80.0138% |
| 3 & 11 | 0.8430% | $94.90 | $94.90 | 80.0002% |
| 3 & 12 | 0.7734% | $103.44 | $103.40 | 79.9696% |
| 4 & 5 | 2.4205% | $33.05 | $33.10 | 80.1190% |
| 4 & 6 | 2.1143% | $37.84 | $37.80 | 79.9218% |
| 4 & 7 | 1.8614% | $42.98 | $43.00 | 80.0402% |
| 4 & 8 | 1.6440% | $48.66 | $48.70 | 80.0616% |
| 4 & 9 | 0.9270% | $86.30 | $86.30 | 79.9985% |
| 4 & 10 | 0.8428% | $94.92 | $94.90 | 79.9850% |
| 4 & 11 | 0.7661% | $104.42 | $104.40 | 79.9841% |
| 4 & 12 | 0.6965% | $114.85 | $114.90 | 80.0320% |
| 5 & 6 | 2.0268% | $39.47 | $39.50 | 80.0569% |
| 5 & 7 | 1.7738% | $45.10 | $45.10 | 79.9994% |
| 5 & 8 | 1.5564% | $51.40 | $51.40 | 79.9988% |
| 5 & 9 | 0.8805% | $90.85 | $90.90 | 80.0407% |
| 5 & 10 | 0.7964% | $100.45 | $100.50 | 80.0371% |
| 5 & 11 | 0.7197% | $111.16 | $111.20 | 80.0290% |
| 5 & 12 | 0.6501% | $123.06 | $123.10 | 80.0261% |
| 6 & 7 | 1.7095% | $46.80 | $46.80 | 80.0032% |
| 6 & 8 | 1.4920% | $53.62 | $53.60 | 79.9737% |
| 6 & 9 | 0.8479% | $94.36 | $94.40 | 80.0378% |
| 6 & 10 | 0.7637% | $104.75 | $104.80 | 80.0369% |
| 6 & 11 | 0.6870% | $116.45 | $116.40 | 79.9676% |
| 6 & 12 | 0.6174% | $129.57 | $129.60 | 80.0166% |
| 7 & 8 | 1.4390% | $55.60 | $55.60 | 80.0057% |
| 7 & 9 | 0.8213% | $97.40 | $97.40 | 79.9995% |
| 7 & 10 | 0.7372% | $108.52 | $108.50 | 79.9865% |
| 7 & 11 | 0.6605% | $121.12 | $121.10 | 79.9864% |
| 7 & 12 | 0.5909% | $135.39 | $135.40 | 80.0084% |
| 8 & 9 | 0.7981% | $100.24 | $100.20 | 79.9711% |
| 8 & 10 | 0.7140% | $112.05 | $112.00 | 79.9644% |
| 8 & 11 | 0.6373% | $125.54 | $125.50 | 79.9767% |
| 8 & 12 | 0.5677% | $140.93 | $140.90 | 79.9846% |
| 9 & 10 | 0.4393% | $182.10 | $182.10 | 79.9991% |
| 9 & 11 | 0.3904% | $204.91 | $204.90 | 79.9956% |
| 9 & 12 | 0.3460% | $231.21 | $231.20 | 79.9951% |
| 10 & 11 | 0.3812% | $209.87 | $209.90 | 80.0109% |
| 10 & 12 | 0.3368% | $237.55 | $237.50 | 79.9835% |
| 11 & 12 | 0.3282% | $243.79 | $243.80 | 80.0046% |
| TOTAL | 100.0000% | 1 | AVERAGE: | 79.9964% |

### EXAMPLE 4

In the fourth example there is a field of 12 runners in the game. Each runner is represented by 5, 6, 7 or 8 Keno balls in the matrix as shown in FIG. 6. Horses 1 and 2 are allocated eight numbers, horses 3 to 8 are allocated seven numbers, horses 9 and 10 are allocated six numbers and horses 11 and 12 are allocated five numbers.

For eighty Keno balls in the Keno matrix and twenty drawn Keno results relevant to determine race result, there are 61,705,898 different outcomes of ball quantities drawn against each runner.

The win, place and quinella odds are shown in Tables 10, 11 and 12 respectively.

TABLE 10
WIN DIVIDENDS CALCULATOR

| | | Target | | Desired RTP 80% |
|---|---|---|---|---|
| | Actual | Dividend | Rounded $1 | Rounded Player |
| Result | Probability | for $1 | Dividend | Return |
| 1 | 23.1121% | $3.46 | $3.50 | 80.8924% |
| 2 | 19.1499% | $4.18 | $4.20 | 80.4295% |
| 3 | 11.1559% | $7.17 | $7.20 | 80.3223% |
| 4 | 9.7239% | $8.23 | $8.20 | 79.7361% |
| 5 | 8.5227% | $9.39 | $9.40 | 80.1136% |
| 6 | 7.5145% | $10.65 | $10.60 | 79.6537% |
| 7 | 6.6727% | $11.99 | $12.00 | 80.0726% |
| 8 | 5.9751% | $13.39 | $13.40 | 80.0658% |
| 9 | 3.0472% | $26.25 | $26.30 | 80.1411% |
| 10 | 2.8148% | $28.42 | $28.40 | 79.9416% |
| 11 | 1.1896% | $67.25 | $67.20 | 79.9440% |
| 12 | 1.1216% | $71.33 | $71.30 | 79.9666% |
| TOTAL | 100.0000% | 1 | AVERAGE: | 80.1066% |

TABLE 11
PLACE DIVIDENDS CALCULATOR

| | | Target | | Desired RTP 80% |
|---|---|---|---|---|
| | Actual | Dividend | Rounded $1 | Rounded Player |
| Result | Probability | for $1 | Dividend | Return |
| 1 | 52.1702% | $1.53 | $1.50 | 78.2553% |
| 2 | 47.0155% | $1.70 | $1.70 | 79.9263% |
| 3 | 33.7143% | $2.37 | $2.40 | 80.9143% |
| 4 | 29.5209% | $2.71 | $2.70 | 79.7063% |
| 5 | 26.3864% | $3.03 | $3.00 | 79.1592% |
| 6 | 24.2040% | $3.31 | $3.30 | 79.8733% |
| 7 | 22.6916% | $3.53 | $3.50 | 79.4205% |
| 8 | 21.5454% | $3.71 | $3.70 | 79.7180% |
| 9 | 14.0000% | $5.71 | $5.70 | 79.7998% |
| 10 | 13.4737% | $5.94 | $5.90 | 79.4946% |
| 11 | 7.7413% | $10.33 | $10.30 | 79.7355% |
| 12 | 7.5368% | $10.61 | $10.60 | 79.8903% |
| TOTAL | 300.0000% | | AVERAGE: | 79.6578% |

TABLE 12
QUINELLA DIVIDENDS CALCULATOR

| | | Target | | Desired RTP 80% |
|---|---|---|---|---|
| | Actual | Dividend | Rounded $1 | Rounded Player |
| Result | Probability | for $1 | Dividend | Return |
| 1 & 2 | 8.8357% | $9.05 | $9.10 | 80.4052% |
| 1 & 3 | 5.1655% | $15.49 | $15.50 | 80.0657% |
| 1 & 4 | 4.4528% | $17.97 | $18.00 | 80.1506% |
| 1 & 5 | 3.9471% | $20.27 | $20.30 | 80.1253% |
| 1 & 6 | 3.5529% | $22.52 | $22.50 | 79.9399% |
| 1 & 7 | 3.2253% | $24.80 | $24.80 | 79.9879% |
| 1 & 8 | 2.9447% | $27.17 | $27.20 | 80.0965% |
| 1 & 9 | 1.6688% | $47.94 | $47.90 | 79.9342% |
| 1 & 10 | 1.5609% | $51.25 | $51.30 | 80.0759% |
| 1 & 11 | 0.7837% | $102.08 | $102.10 | 80.0160% |
| 1 & 12 | 0.7481% | $106.94 | $106.90 | 79.9676% |
| 2 & 3 | 4.6588% | $17.17 | $17.20 | 80.1306% |
| 2 & 4 | 3.9460% | $20.27 | $20.30 | 80.1045% |
| 2 & 5 | 3.4403% | $23.25 | $23.30 | 80.1586% |
| 2 & 6 | 3.0461% | $26.26 | $26.30 | 80.1127% |
| 2 & 7 | 2.7185% | $29.43 | $29.40 | 79.9252% |
| 2 & 8 | 2.4379% | $32.81 | $32.80 | 79.9647% |
| 2 & 9 | 1.3660% | $58.57 | $58.60 | 80.0472% |
| 2 & 10 | 1.2582% | $63.59 | $63.60 | 80.0186% |
| 2 & 11 | 0.6226% | $128.50 | $128.50 | 80.0004% |
| 2 & 12 | 0.5869% | $136.30 | $136.30 | 79.9985% |
| 3 & 4 | 2.5429% | $31.46 | $31.50 | 80.1012% |
| 3 & 5 | 2.2015% | $36.34 | $36.30 | 79.9140% |
| 3 & 6 | 1.9344% | $41.36 | $41.40 | 80.0859% |
| 3 & 7 | 1.7114% | $46.75 | $46.70 | 79.9216% |
| 3 & 8 | 1.5196% | $52.65 | $52.60 | 79.9313% |
| 3 & 9 | 0.8497% | $94.15 | $94.10 | 79.9586% |
| 3 & 10 | 0.7757% | $103.13 | $103.10 | 79.9734% |
| 3 & 11 | 0.3831% | $208.83 | $208.80 | 79.9896% |
| 3 & 12 | 0.3586% | $223.11 | $223.10 | 79.9966% |
| 4 & 5 | 2.0908% | $38.26 | $38.30 | 80.0792% |
| 4 & 6 | 1.8238% | $43.86 | $43.90 | 80.0645% |
| 4 & 7 | 1.6007% | $49.98 | $50.00 | 80.0367% |
| 4 & 8 | 1.4090% | $56.78 | $56.80 | 80.0288% |
| 4 & 9 | 0.7886% | $101.45 | $101.40 | 79.9641% |
| 4 & 10 | 0.7146% | $111.96 | $112.00 | 80.0318% |
| 4 & 11 | 0.3538% | $226.09 | $226.10 | 80.0022% |
| 4 & 12 | 0.3293% | $242.93 | $242.90 | 79.9898% |
| 5 & 6 | 1.7497% | $45.72 | $45.70 | 79.9620% |
| 5 & 7 | 1.5267% | $52.40 | $52.40 | 79.9968% |
| 5 & 8 | 1.3349% | $59.93 | $59.90 | 79.9593% |
| 5 & 9 | 0.7498% | $106.69 | $106.70 | 80.0082% |
| 5 & 10 | 0.6758% | $118.38 | $118.40 | 80.0161% |
| 5 & 11 | 0.3370% | $237.42 | $237.40 | 79.9935% |
| 5 & 12 | 0.3124% | $256.05 | $256.10 | 80.0141% |
| 6 & 7 | 1.4700% | $54.42 | $54.40 | 79.9704% |
| 6 & 8 | 1.2783% | $62.58 | $62.60 | 80.0195% |
| 6 & 9 | 0.7212% | $110.92 | $110.90 | 79.9842% |
| 6 & 10 | 0.6472% | $123.61 | $123.60 | 79.9935% |
| 6 & 11 | 0.3254% | $245.86 | $245.90 | 80.0124% |
| 6 & 12 | 0.3009% | $265.90 | $265.90 | 79.9993% |
| 7 & 8 | 1.2306% | $65.01 | $65.00 | 79.9902% |
| 7 & 9 | 0.6974% | $114.71 | $114.70 | 79.9919% |
| 7 & 10 | 0.6234% | $128.33 | $128.30 | 79.9784% |
| 7 & 11 | 0.3160% | $253.13 | $253.10 | 79.9903% |
| 7 & 12 | 0.2915% | $274.43 | $274.40 | 79.9927% |
| 8 & 9 | 0.6764% | $118.27 | $118.30 | 80.0187% |
| 8 & 10 | 0.6024% | $132.81 | $132.80 | 79.9952% |
| 8 & 11 | 0.3078% | $259.88 | $259.90 | 80.0057% |
| 8 & 12 | 0.2833% | $282.38 | $282.40 | 80.0065% |
| 9 & 10 | 0.3685% | $217.11 | $217.10 | 79.9963% |
| 9 & 11 | 0.1904% | $420.10 | $420.10 | 80.0004% |
| 9 & 12 | 0.1748% | $457.75 | $457.80 | 80.0087% |
| 10 & 11 | 0.1872% | $427.44 | $427.40 | 79.9922% |
| 10 & 12 | 0.1715% | $466.48 | $466.50 | 80.0029% |
| 11 & 12 | 0.0951% | $840.89 | $840.90 | 80.0013% |
| TOTAL | 100.0000% | | AVERAGE: | 80.0181% |

It will apparent to persons skilled in the art that any other appropriate arrangement of number of participants and size of subsets can be chosen in order to vary the spread of the odds. Considerations will include providing an appropriate spread of odds from highest to lowest ranked horse. Typically where subsets of different sizes are allocated, this will be done by allocating bigger subsets of identifiers to the higher ranked horses and lower numbers to lower ranked horses to thereby spread the odds. However, persons skilled in the art will appreciate that other permutations may be desirable in order to vary the odds. For example, if it is desired to have one or two horses in the race which have more similar odds than are otherwise available because of the pre-eminence given to the highest ranked horse.

Persons skilled in the art will also appreciate that the highest ranked horse need not be numbered horse number one and that other horse numberings could be used or indeed names could be used in order to identify horses. Thus it will be appreciated that herein the term “rank” is used to indicate the order in which horses are favoured in determining the result. These and other variations will be apparent to persons skilled in the art. For example, the racing game could be run using ball draw out of different numbers of balls so that it can be run in conjunction with other number draw games or, run independently of a ball selection game. The number of identifiers in the set of identifiers and the number of identifiers in the result subset can be varied in order to vary the odds of the game and the participants are horses.

Persons skilled in the art will also appreciate that the method of the preferred embodiment can readily be encoded in software to run on the host computer 101. In this respect, the host computer 101 may include the identifier selector which selects a random subset of identifiers from a set of identifiers or the identifier selector may be provided by an alternative piece of apparatus. For example, a computer configured to generate a Keno result to thereby keep the two processes separate.

Further modifications will be apparent to persons skilled in the art and fall within the scope of this invention.

1. A method of generating a result of a racing game having a plurality of participants to enable fixed odds betting on the racing game, the result of the racing game being generated from the result of an identifier selection game, the method comprising:
allocating unique subsets of a set of identifiers used in the identifier selection game to each of the plurality of participants;
defining a ranking of said participants from highest to lowest;
running said identifier selection game by randomly selecting a result subset of identifiers from the set of identifiers; and
determining first place in said race by determining which of said plurality of participants has the most identifiers of said result subset in the participant's allocated subset, and if two or more participants have the same number of identifiers in their respective allocated subsets, determining first place by determining which of the two or more participants is ranked highest.

2. A method as claimed in claim 1, wherein generating the result involves generating second place, and wherein if first place was determined by rank, second place is determined by the next highest rank, and if first place is determined by the number of identifiers in the allocated subset of the first placed participant, second place is determined as being the highest ranked participant which has the next greatest number of identifiers of their allocated subset.

3. A method as claimed in claim 2, wherein further places are decided as necessary in an order defined firstly by the number of identifiers in respective participant's allocated subsets and secondly by the relative rankings of the participants.

4. A method as claimed in claim 1 wherein each participant's subset is the same size.

5. A method as claimed in claim 1 comprising allocating subsets of different numbers of identifiers to at least some of the participants.

6. A method as claimed in claim 5 comprising allocating larger subsets to higher ranked participants than to lower ranked participants so that the relative odds of each participant winning are consistent with the participant's ranking.

7. A method as claimed in claim 1 wherein the participants are horses in an animated horse race.

8. A method as claimed in claim 1 wherein identifiers are numbers.

9. A method as claimed in claim 8 wherein the set of numbers is eighty numbers and the result subset consists of twenty numbers randomly selected from the set of eighty.

10. A method as claimed in claim 1 wherein the number of participants and the sizes of the subsets is selected from one of:
eight participants with a subset size of ten;
ten participants with subsets of eight;
twelve participants with the eight highest ranked participants having subsets of seven and the four lowest ranked participants having subsets of six;
twelve participants with two participants having subsets of eight, six participants having subsets of seven, two participants having subsets of six and two participants having subsets of five.

11. A method as claimed in claim 1, wherein the set of identifiers are displayed as a matrix and contiguous portions of the matrix are allocated to each participant when allocating the subsets, whereby it can readily be determined by inspecting the matrix to which participant identifiers in said result set belong.

12. Apparatus for generating a result of a racing game having a plurality of participants to enable fixed odds betting on the racing game the result of the racing game being generated from the result of an identifier selection game, the apparatus comprising:
an identifier selector for randomly selecting a result subset of identifiers from a set of identifiers to thereby generate a result of the identifier selection game; and
a result generator for determining first place in said race by determining which of said plurality of participants has the most identifiers of said result subset in a participant allocated unique subsets of identifiers, and if two or more participants have the same number of identifiers in their respective allocated subsets, determining first place by determining which of the two or more participants is ranked highest from pre-allocated rankings of said participants from highest to lowest.

13. Apparatus as claimed in claim 12 wherein generating the result involves generating a second place, and wherein the result generator is configured such that if first place was determined by rank, the result generator determines second place by the next highest rank, if first place is determined by the number of identifiers in the allocated subset of the first placed participant, the result generator determines second place as being the highest ranked participant which has the next greatest number of identifiers in their allocated subset.

14. Apparatus as claimed in claim 13 wherein the result generator is configured to determine further places as necessary in an order defined firstly by the number of identifiers and secondly by the relative rankings of the participants.

15. Apparatus as claimed in claim 12 wherein said identifier selector comprises a computing device that constitutes said identifier selector and said result generator, said computing device having a memory for storing said allocated identifiers and said rankings.
